(19) United States
(12) Patent Application Publication
(10) Pub. No.: US 2009/0266712 A1
(43) Pub. Date: Oct. 29, 2009

(54) CALCIUM ION SENSORS AND FABRICATION METHOD THEREOF, AND SENSING SYSTEMS COMPRISING THE SAME

(75) Inventors: Jung-Chuan Chou, Yunlin County (TW); Hsiao-Fang Sung, Taichung County (TW); Wei-Lun Hsia, Nantou County (TW); Ya-Ping Huang, Tainan City (TW)

Correspondence Address: QUINTERO LAW OFFICE, PC, 2210 MAIN STREET, SUITE 200, SANTA MONICA, CA, 90405, US

(73) Assignee: NATIONAL YUNLIN UNIVERSITY OF SCIENCE AND TECHNOLOGY, Yunlin (TW)

(21) Appl. No.: 12/349,428

(22) Filed: Jan. 6, 2009

(30) Foreign Application Priority Data
Apr. 28, 2008 (TW) TW097115538

(51) Int. Cl. G01N 27/416

(52) U.S. Cl. 204/415; 427/126.5; 204/416

(57) ABSTRACT

A calcium ion sensor is provided. The calcium ion sensor includes a metal oxide semiconductor field effect transistor, a sensing unit including a substrate, a ruthenium dioxide membrane formed thereon and a calcium ion sensing membrane formed on the ruthenium dioxide membrane, and a conductive wire connecting the metal oxide semiconductor field effect transistor and the sensing unit. The invention also provides a method for fabricating a calcium ion sensor, and a sensing system including the sensor.

### CROSS REFERENCE TO RELATED APPLICATIONS

This Application claims priority of Taiwan Patent Application No. 097115538, filed on Apr. 28, 2008, the entirety of which is incorporated by reference herein.

### BACKGROUND OF THE INVENTION

1. Field of the Invention

The invention relates to a sensor, and more particularly to a calcium ion sensor and a sensing system comprising the same.

2. Description of the Related Art

Ion sensitive electrodes (ISE) used for calcium ion sensing, especially in clinical biochemical analysis, are currently popularly used. However, it is difficult to miniaturize ISEs due to its large volume and fragile characteristics. Additionally, ISEs are relatively costly, and thus are suitable mostly for use in specialized biochemical analytical instruments. Thus, mass and economic use of biomedical measurements using ISEs in locations such as a home, is currently not feasible.

In J. Van Der Spiegel et al. (J. Van Der Spiegel, I. Lauks, P. Chan, D. Babic, “The extended gate chemical sensitive field effect transistor as multi-species microprobe”, Sensors and Actuators B, Vol. 4, pp. 291-298, 1983), a structure of an extended gate field effect transistor (EGFET) to modify an ion sensitive field effect transistor (ISFET) is disclosed. In the EGFET, a sensing area is separated from a gate of a metal oxide semiconductor field effect transistor (MOSFET) and connected therewith by a conductor (conductive wire). Compared to the ISFET, the EGFET possesses merits, such as, providing static electricity protection for transistor units by the conductive wire, preventing a test solution to directly contact an electrically active region, and providing a low-cost process compatible with MOSFET fabrication.

A number of patents related thereto have been disclosed as summarized hereinafter.

To begin, U.S. Pat. No. 4,992,382, inventors: Marc D. Porter and Lai-Kwan Chau, filing date: Aug. 21, 1989, title: “Porous polymer film calcium ion chemical sensor and method of using the same” has been disclosed. The patent discloses a method for measuring calcium ions, wherein a calcium sensitive reagent, calcichrome, is immobilized on a porous polymer film. The reaction of the calcium sensitive reagent to the Ca(II) is then measured and concentration is then determined as a function of the reaction.

Next, U.S. Pat. No. 5,496,522, inventors: Tuan Vo-Dinh and Pierre Viallet, filing date: Feb. 7, 1994, title: “Biosensor and chemical sensor probes for calcium and other metal ions” has also been disclosed. The invention relates to chemical sensors and biosensor probes for measuring low concentration of metals and metal ions in complex samples such as biological fluids, living cells, and environmental samples. More particularly the invention relates to a gel-based Indo-1 and Fura-2 chemical sensor probes for the measurement of low concentrations of the calcium, cadmium, magnesium and the like. Also disclosed is a detector device using the sensors of the invention.

Also, U.S. Pat. No. 5,705,620, inventors: Allan Milton Byrnard, Rocco Ungaro and Andrea Pochini, filing date: Jan. 6, 1998, title: “Sensors for detecting calcium with calyx(4) arene compounds” has been disclosed. The patent discloses a calyx(4) arene compound, application of the compound as an active component in a calcium sensitive sensor, and a calcium sensitive sensor containing the compound. The sensor is not very sensitive to sodium and potassium ions.

Next, U.S. Pat. No. 4,946,574, inventors: Lin Chun-Ew, filing date: Aug. 7, 1990, title: “Apparatus for production of sterilized calcium-ion water” has also been disclosed. The patent discloses an apparatus for the production of sterilized and calcium-ion water, which includes the following: a housing structure; an electrolytic cell with electrical terminals and electrodes installed in the housing structure; a plurality of electromagnetic valves separately provided at a water-intake pipe and a water-drain pipe in communication with the electrolytic cell; a setting switch disposed in the housing structure and electrically coupled with the electrolytic cell for adjusting the current intensity of electrolysis therewith; a hydraulic-pressure switch provided at a water pressure pipe for the control of the water-level in the electrolytic cell; an ultraviolet sterilizing tank connected to the electrolytic cell for sterilizing the electrolyzed water; and a control circuit respectively coupled with the electrolytic cell, the electromagnetic valves and the setting and hydraulic switches; whereby, calcium-ion water can be effectively produced for drinking purposes.

Also, U.S. Pat. No. 4,877,582, inventors: Oda Shohei, Seshimoto Osamu, Sueyoshi Tohru and Amano Hiroyuki, filing date: Aug. 20, 1987, title: “Chemical sensor device with field effect transistor” has been disclosed. The patent discloses a chemical sensor having a field-effect transistor as an electronic transducer and used for the analysis of specific constituents in a liquid. The chemical sensor comprises means which permits an externally supplied sample solution to reach a chemical receptor of the chemical sensor of the invention, but substantially prevents external light from reaching the field effect transistor of the invention.

Additionally, U.S. Pat. No. 4,812,220, inventors: Takeaki Iida and Takeshi Kawabe, filing date: Aug. 12, 1987, title: “Enzyme sensor for determining a concentration of glutamate” has also been disclosed. The patent discloses an enzyme sensor for determining a concentration of glutamate. The enzyme sensor comprises an immobilize enzyme reacting specifically to a substrate and a transducer for converting the quantitative change of a substance or heat which is produced or consumed during an enzyme reaction to an electrical signal. The enzyme is glutamine synthetase and the transducer is the pH glass electrode or ion-sensitive field-effect transistor (ISFET). The enzyme sensor can be miniaturized and can accurately determine a concentration of glutamate even when volume of the glutamate is low.

Lastly, TW Pat. No. 1256470, inventors: Shen-Kan Hsiung, Jung-Chuan Chou, Tai-Ping Sun, and Han-Chou Liao, filing date: Jun. 11, 2006, title: “Multi-parameter sensor with readout circuit” has also been disclosed. In the patent, an ion sensor comprises a readout circuit. The ion sensor is a kind of electrochemical sensor, and can be used as a dual mode sensor, such as potentiometric and amperometric ion sensors. The same circuit system and be read out by the different mode sensors of different. Therefore, making the measurement circuit system suitable for different mode sensors.

### BRIEF SUMMARY OF THE INVENTION

One embodiment of the invention provides a calcium ion sensor comprising a metal oxide semiconductor field effect transistor, a sensing unit comprising a substrate, a ruthenium dioxide membrane formed thereon and a calcium ion sensing membrane formed on the ruthenium dioxide membrane, and a conductive wire connecting the metal oxide semiconductor field effect transistor and the sensing unit.

One embodiment of the invention provides a method for fabricating a calcium ion sensor comprising providing a metal oxide semiconductor field effect transistor, providing a sensing unit comprising a substrate, a ruthenium dioxide membrane formed thereon and a calcium ion sensing membrane formed on the ruthenium dioxide membrane, and providing a conductive wire to connect the metal oxide semiconductor field effect transistor and the sensing unit.

One embodiment of the invention provides a sensing system comprising the disclosed calcium ion sensor, a reference electrode applying a stabilized voltage, a semiconductor parameter analyzer connecting the metal oxide semiconductor field effect transistor of the calcium ion sensor and the reference electrode, and a light-isolation container containing the sensing unit of the calcium ion sensor, the reference electrode and a test solution.

One embodiment of the invention provides a sensing system comprising the disclosed calcium ion sensor, a reference electrode applying a stabilized voltage, an amplifier containing the sensing unit of the calcium ion sensor, a microprocessor control unit connecting the amplifier, and a container containing the sensing unit of the calcium ion sensor, the reference electrode and a test solution.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawing, wherein:

FIG. 1 shows a cross-sectional view of a calcium ion sensor according to an embodiment of the invention.

FIG. 2 shows a sensing system according to an embodiment of the invention.

FIG. 3 shows a sensing system according to an embodiment of the invention.

FIG. 4 shows a relationship between gate voltage of a calcium ion sensor and pH of a test solution.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

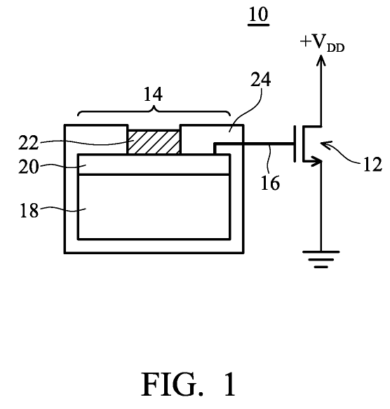

A calcium ion sensor in an embodiment of the invention is disclosed in FIG. 1. A calcium ion sensor 10 comprises a metal oxide semiconductor field effect transistor 12 and a sensing unit 14 connected therewith by a conductive wire 16. The sensing unit 14 comprises a substrate 18, a ruthenium dioxide membrane 20 and a calcium ion sensing membrane 22. The ruthenium dioxide membrane 20 is disposed on the substrate 18. The calcium ion sensing membrane 22 is disposed on the ruthenium dioxide membrane 20. The sensing unit 14 is further covered by an insulating layer 24, exposing the calcium ion sensing membrane 22 to be in contact with a test solution.

The substrate 18 may be a p-type silicon substrate. The calcium ion sensing membrane 22 may comprise polymers such as polyvinyl chloride (PVC), plasticizers such as bis(2-ethylhexyl)sebacate (DOS), ion selective materials such as C₂₉H₃₇N₃O₆, and electronegative ion complexes such as potassium tetrakis(4-chlorophenyl)borate. The conductive wire 16 may be a copper wire. The insulating layer 24 may comprise epoxy resin.

The epoxy resin possesses excellent insulation, low water and electrolyte permeation, high adhesion to sensing membrane, silicon wafer and substrate, chemical stability, anti-corrosion, processibility, proper mobility before solidification, high mechanical strength after solidification and small volume contraction after immersing, suitable for packaging the sensing unit 14.

In the extended gate ion sensitive field effect transistor (EGFET), the calcium ion sensing membrane is separated from a gate thereof to isolate the metal oxide semiconductor field effect transistor (MOSFET) and the test solution, reducing instability of semiconductor devices and avoiding signal interference generated from the test solution.

A method for fabricating a calcium ion sensor in an embodiment of the invention is disclosed in FIG. 1. A metal oxide semiconductor field effect transistor 12 is provided. A sensing unit 14 comprising a substrate 18, a ruthenium dioxide membrane 20 and a calcium ion sensing membrane 22 is then provided. The ruthenium dioxide membrane 20 is formed on the substrate 18 by, for example, radio frequency sputtering. The calcium ion sensing membrane 22 is formed on the ruthenium dioxide membrane 20. A conductive wire 16 is then provided to connect the metal oxide semiconductor field effect transistor 12 and the sensing unit 14. The sensing unit 14 is further covered by an insulating layer 24, exposing the calcium ion sensing membrane 22 to be in contact with the test solution.

The substrate 18 may be a p-type silicon substrate. The calcium ion sensing membrane 22 may comprise polymers such as polyvinyl chloride (PVC), plasticizers such as bis(2-ethylhexyl)sebacate (DOS), ion selective materials such as C₂₉H₃₇N₃O₆, and electronegative ion complexes such as potassium tetrakis(4-chlorophenyl)borate. The conductive wire 16 may be a copper wire. The insulating layer 24 may comprise epoxy resin.

The calcium ion sensing membrane 22 is prepared by the following steps. A polymer, a plasticizer and solvent are mixed to form a polymer solution. Next, an ion selective material and an electronegative ion complex are respectively dissolved in the solvent to form an ion selective material solution and an electronegative ion complex solution. The polymer solution, the ion selective material solution and the electronegative ion complex solution are then ultrasonically shaken. Next, fixed amounts of the polymer solution, the ion selective material solution and the electronegative ion complex solution are uniformly mixed to form a mixing solution. A fixed amount of the mixing solution is then dropped on a substrate. After drying and shaping under room temperature, a calcium ion sensing membrane is prepared.

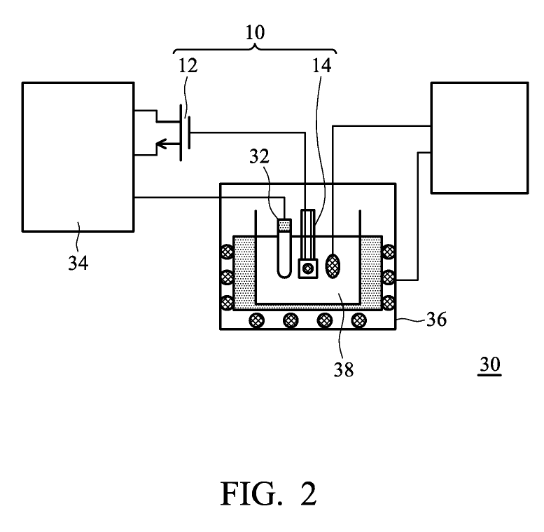

A sensing system in an embodiment of the invention is disclosed in FIG. 2. The sensing system 30 comprises the disclosed calcium ion sensor 10, a reference electrode 32, a semiconductor parameter analyzer 34 and a light-isolation container 36. The semiconductor parameter analyzer 34 connects to the metal oxide semiconductor field effect transistor 12 of the calcium ion sensor 10 and the reference electrode 32. The light-isolation container 36 contains the sensing unit 14 of the calcium ion sensor 10, the reference electrode 32 and a test solution 38.

The reference electrode 32 may be an Ag/AgCl reference electrode, applying a stabilized voltage. The semiconductor parameter analyzer 34 may be a current-voltage instrument, for example, a Keithley 236 for measuring, such as drain current and gate voltage and further processing of electric signals. To avoid being affected by light, the light-isolation container 36 may be a dark box.

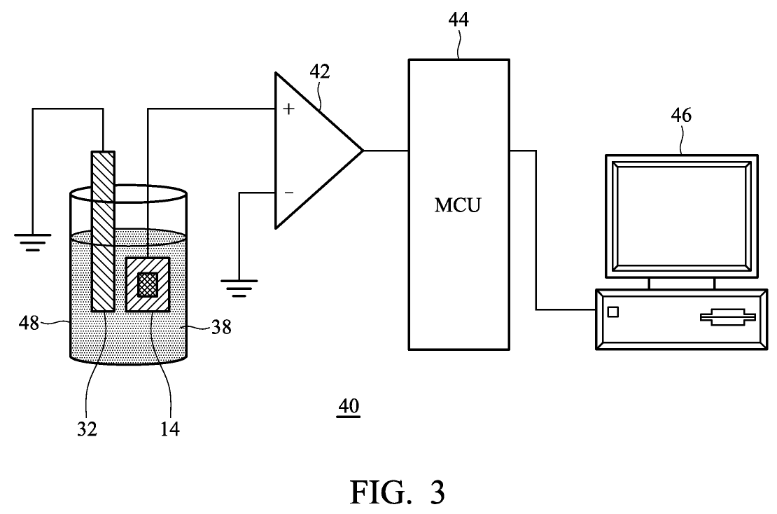

A sensing system in an embodiment of the invention is disclosed in FIG. 3. The sensing system 40 comprises the disclosed calcium ion sensor 10, a reference electrode 32, an amplifier 42, a microprocessor control unit 44, a computer 46 and a container 48. The amplifier 42 connects to the sensing unit 14 of the calcium ion sensor 10. The microprocessor control unit 44 connects to the amplifier 42. The container 48 contains the sensing unit 14 of the calcium ion sensor 10, the reference electrode 32 and a test solution 38.

The reference electrode 32 may be an Ag/AgCl reference electrode, applying a stabilized voltage. The microprocessor control unit 44 converts an analog signal received from the amplifier 42 into a digital signal.

A variation of the original voltage signals of the sensing unit in the test solution is measured and recorded by the amplifier circuit, microprocessor control unit and computer software interface to obtain a characteristic value of the voltage curve of the sensing unit, facilitating subsequent circuit design and data acquisition of the microprocessor control unit. Because the measuring system is a portable measuring circuit, a DAQ data acquisition card with a large size or other commercialized interfaces are unsuitable for use in processing the output signals of the sensing unit, because variations of signals passing through the data acquisition card cannot be precisely controlled and the combination of the data acquisition card and the commercialized interface circuit is too large to miniaturize the measuring circuit. Thus, in the invention, signals of the sensing unit are directly acquired and processed through the microprocessor control unit (MCU) of the measuring system. Referring to FIG. 3, a sensing unit and a reference electrode are connected to an input end of an amplifier. A voltage signal corresponding to the reference electrode of the sensing unit is input to a microprocessor control unit through the amplifier INA118. After converting an analog signal into a digital signal by the microprocessor control unit, the signal is output from RS232 and recorded by a computer. The small voltage signal outputted from the sensing unit is amplified 10 times by the amplifier INA118. The amplified signal is then processed, by A/D conversion, by the microprocessor control unit and the third digit after the decimal point is selected. The A/D conversion frequency is 10 per second. A more smooth voltage curve can be obtained by increasing the A/D conversion frequency, facilitating observation of signal variations. Additionally, a filter capacitor can be further connected to the sensing unit to reduce noise. The recorded signal was then charted and analyzed by a Microsoft Origin 7.0.

### EXAMPLE 1

Preparation of the Calcium Ion Sensing Membrane

0.549 g polyvinyl chloride (PVC), 0.39 g bis(2-ethylhexyl)sebacate (DOS) (plasticizer) and 5 mL tetrahydrofuran (THF) were mixed to prepare a polymer solution. The polymer solution was then shaken in an ultrasonic cleaner for 30 minutes and assigned to a No. 1 sensing membrane formulating solution.

25 mg ETH129 (C₂₉H₃₇N₃O₆) (ion selective material) and 1 mL THF were mixed to prepare a polymer solution. The polymer solution was then shaken in an ultrasonic cleaner for 30 minutes and assigned to a No. 2 sensing membrane formulating solution.

0.1 g potassium tetrakis(4-chlorophenyl)borate (electronegative ion complex) and 1 mL THF were mixed to prepare a polymer solution. The polymer solution was then shaken in an ultrasonic cleaner for 30 minutes and assigned to a No. 3 sensing membrane formulating solution.

25 μL of the No. 1 sensing membrane formulating solution, 2 μL of the No. 2 sensing membrane formulating solution and 0.5 μL of the No. 3 sensing membrane formulating solution were mixed to prepare a mixing solution. The mixing solution was then shaken in an ultrasonic cleaner for 30 minutes. 1 μL of the mixing solution was dropped on the sensing window of the sensing unit. After cool drying for 8 hours, a calcium ion sensing membrane was prepared.

### EXAMPLE 2

Sensitivity of the Calcium Ion Sensing Unit

Current-voltage was measured by a Keithley 236 Current Measure Unit and the unit's Metrics software.

The Keithley 236 semiconductor parameter analyzer was set by the following steps.

(1) The semiconductor parameter analyzer was connected to the drain of the metal oxide semiconductor field effect transistor (MOSFET) by a test fixture. V_{D} of 0.2V was set to ensure the unit was operating under a linear region.

(2) The semiconductor parameter analyzer was connected to the reference electrode by the test fixture. V_{ref} of 1-6V was set. A voltage was applied on the gate of the MOSFET through a test solution.

(3) The semiconductor parameter analyzer was connected to the source of the MOSFET by the test fixture. V_{S} of 0V (grounded) was set.

The most important parameter of the EGFET sensing unit is sensitivity, defined as a relative variation of interface potential between the solution and the surface of the sensing membrane per pH value. A corresponding pH variation of the current-voltage curve of the EGFET sensing unit was measured by a current-voltage measuring system (Keithley 236 Current Measure Unit).

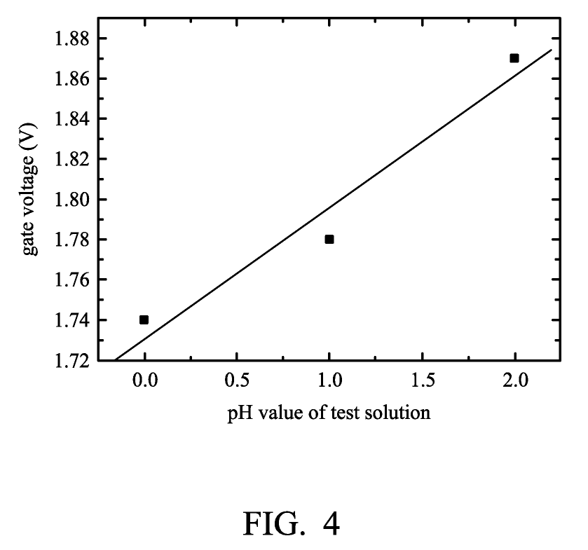

In an embodiment, a corresponding pH variation of the current-voltage curve of the sensing unit was measured by a current-voltage measuring system (Keithley 236 Current Measure Unit). An output voltage was altered with a pH value where I_{DS} was fixed in the current-voltage curve. Data was then analyzed by a Microsoft Origin 7.0 and sensitivity (ΔmV/ΔpCa) of the sensing unit was obtained, as shown in FIG. 4. The calcium ion sensing unit had sensitivity of 32.5 mV/pCa, linearity of 0.976 and a sensing range of pCa0-pCa2.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A calcium ion sensor, comprising:
a metal oxide semiconductor field effect transistor;
a sensing unit comprising a substrate, a ruthenium dioxide membrane formed thereon and a calcium ion sensing membrane formed on the ruthenium dioxide membrane; and
a conductive wire connecting the metal oxide semiconductor field effect transistor and the sensing unit.

2. The calcium ion sensor as claimed in claim 1, wherein the substrate is a p-type silicon substrate.

3. The calcium ion sensor as claimed in claim 1, wherein the calcium ion sensing membrane comprises polymers, plasticizers, ion selective materials and electronegative ion complexes.

4. The calcium ion sensor as claimed in claim 3, wherein the polymer comprises polyvinyl chloride (PVC).

5. The calcium ion sensor as claimed in claim 3, wherein the plasticizer comprises bis(2-ethylhexyl)sebacate (DOS).

6. The calcium ion sensor as claimed in claim 3, wherein the ion selective material comprises C₂₉H₃₇N₃O₆.

7. The calcium ion sensor as claimed in claim 3, wherein the electronegative ion complex comprises potassium tetrakis(4-chlorophenyl)borate.

8. The calcium ion sensor as claimed in claim 1, wherein the conductive wire is a copper wire.

9. The calcium ion sensor as claimed in claim 1, further comprising an insulating layer covering the surface of the sensing unit, exposing the calcium ion sensing membrane.

10. The calcium ion sensor as claimed in claim 9, wherein the insulating layer comprises epoxy resin.

11. A method for fabricating a calcium ion sensor, comprising:
providing a metal oxide semiconductor field effect transistor;
providing a sensing unit comprising a substrate, a ruthenium dioxide membrane formed thereon and a calcium ion sensing membrane formed on the ruthenium dioxide membrane; and
providing a conductive wire to connect the metal oxide semiconductor field effect transistor and the sensing unit.

12. The method for fabricating a calcium ion sensor as claimed in claim 11, wherein the substrate is a p-type silicon substrate.

13. The method for fabricating a calcium ion sensor as claimed in claim 11, wherein the ruthenium dioxide membrane is formed on the substrate by radio frequency sputtering.

14. The method for fabricating a calcium ion sensor as claimed in claim 11, wherein the calcium ion sensing membrane comprise polymers, plasticizers, ion selective materials and electronegative ion complexes.

15. The method for fabricating a calcium ion sensor as claimed in claim 14, wherein the polymer comprises polyvinyl chloride (PVC).

16. The method for fabricating a calcium ion sensor as claimed in claim 14, wherein the plasticizer comprises bis(2-ethylhexyl)sebacate (DOS).

17. The method for fabricating a calcium ion sensor as claimed in claim 14, wherein the ion selective material comprises C₂₉H₃₇N₃O₆.

18. The method for fabricating a calcium ion sensor as claimed in claim 14, wherein the electronegative ion complex comprises potassium tetrakis(4-chlorophenyl)borate.

19. The method for fabricating a calcium ion sensor as claimed in claim 11, wherein the conductive wire is a copper wire.

20. The method for fabricating a calcium ion sensor as claimed in claim 11, further comprising forming an insulating layer to cover the surface of the sensing unit, exposing the calcium ion sensing membrane.

21. The method for fabricating a calcium ion sensor as claimed in claim 20, wherein the insulating layer comprises epoxy resin.

22. A sensing system, comprising:
a calcium ion sensor as claimed in claim 1;
a reference electrode applying a stabilized voltage;
a semiconductor parameter analyzer connecting the metal oxide semiconductor field effect transistor of the calcium ion sensor and the reference electrode; and
a light-isolation container containing the sensing unit of the calcium ion sensor, the reference electrode and a test solution.

23. The sensing system as claimed in claim 22, wherein the reference electrode is an Ag/AgCl reference electrode.

24. The sensing system as claimed in claim 22, wherein the semiconductor parameter analyzer is a current-voltage instrument.

25. The sensing system as claimed in claim 24, wherein the semiconductor parameter analyzer measures a drain current and a gate voltage.

26. The sensing system as claimed in claim 22, wherein the light-isolation container is a dark box.

27. A sensing system, comprising:
a calcium ion sensor as claimed in claim 1;
a reference electrode applying a stabilized voltage;
an amplifier containing the sensing unit of the calcium ion sensor;
a microprocessor control unit connecting the amplifier; and
a container containing the sensing unit of the calcium ion sensor, the reference electrode and a test solution.

28. The sensing system as claimed in claim 27, wherein the reference electrode is an Ag/AgCl reference electrode.

29. The sensing system as claimed in claim 27, wherein the microprocessor control unit converts an analog signal received from the amplifier into a digital signal.
